(19) United States
(12) Patent Application Publication
(10) Pub. No.: US 2015/0100327 A1
(43) Pub. Date: Apr. 9, 2015

(54) MAINTAINING CONTEXT BETWEEN APPLICATIONS UTILIZING A PRIORITIZED PATIENT LIST

(71) Applicant: CERNER INNOVATION, INC., Kansas City, KS (US)

(72) Inventors: LISA KELLY, Overland Park, KS (US); JUDITH A. ZAKUTNY, Olathe, KS (US); JOSHUA J. DAVIS, Kansas City, MO (US); FRANCIS G. RYDZEWSKI, Kansas City, MO (US)

(73) Assignee: CERNER INNOVATION, INC., Kansas City, KS (US)

(21) Appl. No.: 14/045,956

(22) Filed: Oct. 4, 2013

(51) Int. Cl. G06F 19/00

(52) U.S. Cl. CPC G06F 19/3418
USPC 705/2

(57) ABSTRACT

Methods, computer systems, and computer-storage medium are provided for maintaining context between applications utilizing prioritized patient lists. A selection of patients is received from a clinician. A patient list is prioritized. A preview of information from more than one application is provided without requiring each application to launch. A selection of a patient from the patient list is received. More than one application is launched for the patient based on context passed from the patient list to each application.

### BACKGROUND

Clinicians tasked with monitoring patients in a remote environment (i.e., telemonitoring) have many responsibilities. Priority must be maintained, alerts must be monitored, medications must be ordered, results must be analyzed, patient histories and care plans must be observed, and video must be inspected, often for many patients at a time. This requires constant searching and scrolling to identify the correct patient, opening and closing multiple applications supporting each of these functions, and checking for new items that may only appear in each of the separate applications. Each of these tasks affects efficiency and accuracy. Exacerbating this problem further, there is no single front-end driver that allows context for each patient in each application to be maintained from a single source or opening and closing each application. This requires additional time to define context in other locations or requires opening other applications. The result is inefficiency for the telemonitoring clinician, as well as increased opportunities for error.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-storage media for maintaining context between applications utilizing prioritized patient lists. A selection of patients is received from a clinician. A patient list is prioritized. A preview of information from more than one application is provided without requiring each application to launch. A selection of a patient from the patient list is received. More than one application is launched for the patient based on context passed from the patient list to each application.

### BRIEF DESCRIPTION OF THE DRAWINGS

Embodiments are described in detail below with reference to the attached drawing figures, wherein:

FIG. 1 is a block diagram of an exemplary computing environment suitable to implement embodiments of the present invention;

FIG. 2 is a block diagram of an exemplary system for maintaining context between applications utilizing prioritized patient lists suitable to implement embodiments of the present invention;

FIGS. 3A-3B depict illustrative screen displays, in accordance with exemplary embodiments of the present invention;

FIGS. 4-5 depict illustrative screen displays, in accordance with exemplary embodiments of the present invention; and

FIG. 6 is a flow diagram of an exemplary method of maintaining context between applications utilizing prioritized patient lists, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-storage media for maintaining context between applications utilizing prioritized patient lists. The context is passed from the prioritized patient lists to each application that is launched for a patient. Context may be created and maintained with contextual identifiers. Contextual identifiers for an application, which may include one or more electronic medical records (EMRs), are mapped and resolved to contextual identifiers for each application, component, device, etc. Each application may be provided by a disparate system and the contextual identifiers enable any defined context (e.g., billing claim, hospital location, etc.) to be shared with any interested parties, including messages instructing applications to stop showing a particular context or close. The context mappings may be achieved by creating or providing additional agents that understand how to achieve the mapping based on the source system that is participating in context sharing. Source systems may include a network, a device, or other EMR (e.g., database, HL7 interface, etc.). Although the context may utilize the prioritized patient lists as the driver, any agents/consumers may participate as long as the resolution of contextual identifiers is achieved. For example, a patient list within another application may operate as the driver so long as context is mapped and resolved via the contextual identifiers. The contextual identifiers may be transparent to end-users so the end-users are not responsible for understanding how the applications, components, devices, etc. are mapped and resolved. The contextual identifiers may allow applications to be launched into context (i.e., launched for the appropriate patient with the appropriate information at the appropriate time, etc.) as well as maintained between applications that are already launched.

Accordingly, one embodiment of the present invention is directed to one or more computer hardware storage media storing computer-useable instructions that, when used by one or more computing devices, cause the one or more computing devices to perform a method of maintaining context between applications utilizing prioritized patient lists. The method includes receiving a selection of patients from a clinician. A patient list is prioritized. A preview of information from more than one application is provided without requiring each application to launch. A selection of a patient from the patient list is received. More than one application for the patient is launched based on context passed from the patient list to each application.

Another embodiment of the present invention includes a system for maintaining context between applications utilizing prioritized patient lists. The system includes one or more processors coupled to a computer storage medium, the computer storage medium having stored thereon a plurality of computer software components executable by the processor. The computer software components include a selection component. The selection component receives a selection of patients from a clinician. A priority component prioritizes a patient list. A preview component provides a preview of information from more than one application without requiring each application to launch. A patient component receives a selection of a patient from the patient list. A launch component launches more than one application. The more than one application is launched based on context passed from the patient list to each application.

Yet another embodiment of the present invention is directed to computer storage media having computer-executable instructions embodied thereon that, when executed by one or more computing devices, cause the one or more computing devices to produce a graphical user interface (GUI) for maintaining context between applications utilizing prioritized patient lists. The GUI includes a prioritized patient list display area that displays a prioritized patient list comprising a summary of data received from more than one application. The prioritized patient list comprises a selection of patients received from a clinician. A patient summary display area displays, after a summary interaction is received for a patient, a patient summary for the patient provided by one of the applications without launching the application that provides the data displayed in the patient summary.

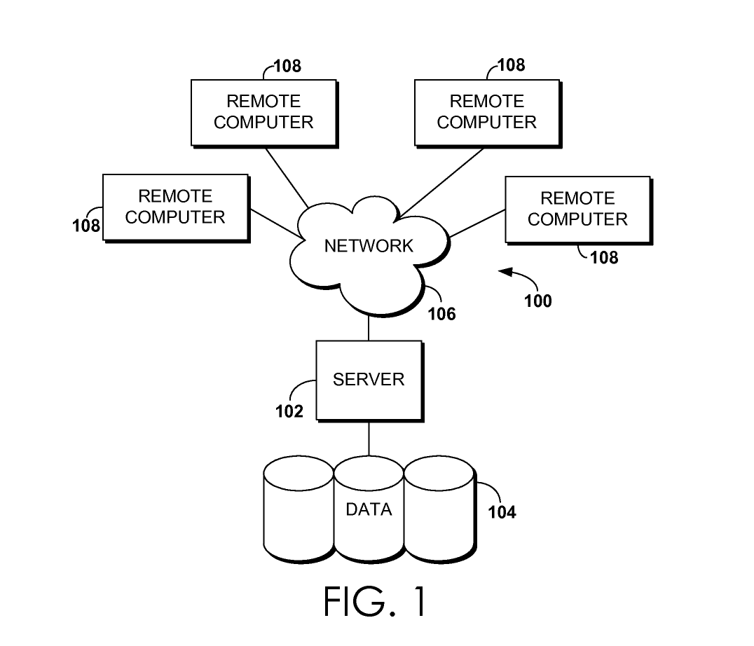

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, ambulatory settings, medical billing and financial offices, hospital administration settings, home healthcare environments, and clinicians' offices. Clinicians may comprise a treating physician or physicians; specialists such as intensivists, surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a pointing device (commonly referred to as a mouse), a trackball, or a touch pad. Other input devices comprise microphones, satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

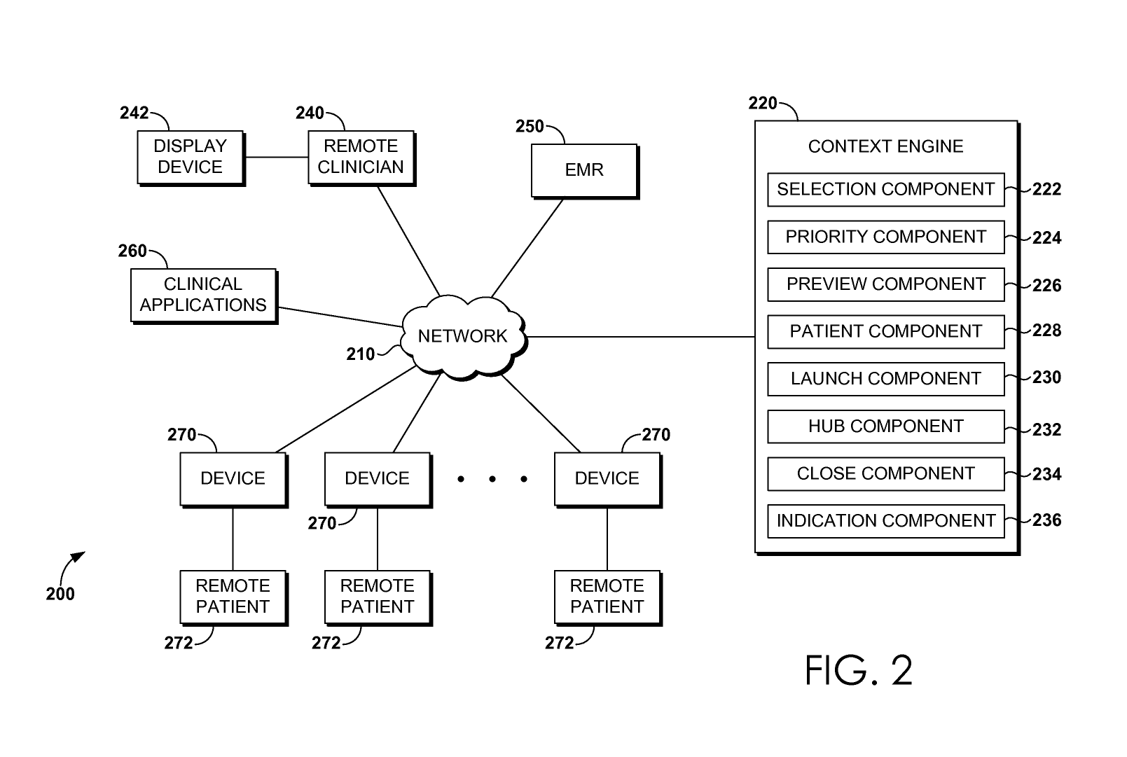

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a display device 242 (e.g., dashboard, computer, mobile device, and the like), context engine 220, EMR 250, clinical applications 260, and medical devices 260 all in communication with one another via a network 210. The network 202 may include, without limitation, one or more secure local area networks (LANs) or wide area networks (WANs). The network 202 may be a secure network associated with a facility such as a healthcare facility. The secure network 202 may require that a user log in and be authenticated in order to send and/or receive information over the network 202.

In some embodiments, one or more of the illustrated components/modules may be implemented as stand-alone applications. In other embodiments, one or more of the illustrated components/modules may be distributed across multiple context engines 220. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the context engines 220 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The clinical applications 260 and the EMR 250 are configured to provide and store information for use by, for example, the context engine 220. The information stored in association with the clinical applications 260 and the EMR 250 is configured to be searchable for one or more items of information stored in association therewith. The information stored in association with the clinical applications 260 and the EMR 250 may comprise information used by various components of the context engine 220.

The EMR 250 may store EMRs of patients associated with one or more healthcare facilities. EMRs may comprise electronic clinical documents such as images, clinical notes, orders, summaries, reports, analyses, information received from clinical applications 260 and medical devices 270, or other types of electronic medical documentation relevant to a particular patient's condition and/or treatment. Electronic clinical documents contain various types of information relevant to the condition and/or treatment of a particular patient and can include information relating to, for example, patient identification information, images, alert history, culture results, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, clinician assignments, and a host of other relevant clinical information.

The content and volume of such information in the clinical applications 260 and the EMR 250 are not intended to limit the scope of embodiments of the present invention in any way. Further, though illustrated as a single, independent component, the clinical applications 250 and the EMR 250 may, in fact, include a plurality of applications and/or storage devices, for instance, a database cluster.

The display device 242 may be any type of display device capable of communicating via the network 210 with the context engine 220, the EMR 250, clinical applications 260, or the medical devices 270. Such devices may include any type of mobile and portable devices including cellular telephones, personal digital assistants, tablet PCs, smart phones, and the like.

The display of the display device 242 is configured to display information to the user of the display device 210 (i.e., the remote clinician 240). The information may include communications initiated by and/or received by the context engine 220. Embodiments are not intended to be limited to visual display but rather may also include audio presentation, visual presentation, combined audio/visual presentation, and the like.

Components of the context engine 220 may include a processing unit, internal system memory, and a suitable system bus for coupling various system components, including one or more data stores for storing information (e.g., files and metadata associated therewith). The context engine 220 typically includes, or has access to, a variety of computer-readable media.

The computing system environment 200 is merely exemplary. While the context engine 220 is illustrated as a single unit, it will be appreciated that the context engine 220 is scalable. For example, the context engine 220 may in actuality include a plurality of computing devices in communication with one another. The single unit depictions are meant for clarity, not to limit the scope of embodiments in any form.

As shown in FIG. 2, the context engine 220 comprises, in various embodiments a selection component 222, a priority component 224, a preview component 226, a patient component 228, a launch component 230, a hub component 232, a close component 234, and an indication component 236. In some embodiments, one or more of the components may be implemented as stand-alone applications. It will be understood that the components illustrated in FIG. 2 are exemplary in nature and in number and should not be construed as limiting. Any number of components may be employed to achieve the desired functionality within the scope of embodiments hereof.

Selection component 222 receives a selection of patients from a clinician. The selection may be made automatically. In one embodiment, the selection is based on patient assignments associated with the clinician. In one embodiment, the selection is based on a location of the clinician. In one embodiment, the selection is based on a role of the clinician. In one embodiment, the selection is based on information associated with the patients (e.g, location of the patient, diagnosis of the patient, and the like). In one embodiment, the patients are selected manually by the clinician.

Priority component 224 prioritizes a patient list. In one embodiment, the patient list may be prioritized by data received from EMR 250, clinical applications 260, devices 270, or any combination thereof. For example, each patient may be associated with data stored in the EMR 250. The data may indicate that one patient has a condition, alert, diagnosis, risk level and the like that makes that patient higher priority than another patient. Further, data received from clinical applications 260 or devices 270 may similarly indicate that one patient should be higher priority than another patient. The priority component 224 may establish the priority for each patient based on a set of defined or configurable rules based on the data received allowing the priority component 224 to establish or modify the priority in real-time. In one embodiment, the patient list may be prioritized manually by the clinician. For example, the clinician may observe a data point (e.g., an alert or something on the video feed) that causes the clinician to believe that the priority for a particular patient should be increased or decreased with respect to other patients on the patient list. In this instance, the clinician may manually adjust the priority settings thereby changing the order of the patients on the prioritized patient list. Accordingly, the priority component 224 prioritizes the patient list so the clinician can monitor the patients with higher priority first.

Preview component 226 provides a preview of information from more than one application without requiring each application to launch. The preview may include specific data items received by the context engine 220 from the EMR 250, clinical applications 260, and/or medical devices 270. The data items may be configured or defined by the particular healthcare facility or group of facilities, a facility the particular patient is associated with, or by the clinician. The preview may be configured or defined such that each clinician responsible for a particular patient are provided the same data items. These data items are passed through the context engine 220 to the preview component 226 so the preview is provided without requiring launching the application or EMR where the particular data item originated. In other words, the clinician is provided data from the clinical applications 260 and the EMR 250 without launching a local instance of the originating application. Rather, the context engine 220 passes the context associated with the patient (including the requested data and any necessary credentials) remotely to the originating application and the originating application passes back the data that is provided by preview component 226 in the preview.

Patient component 228 receives a selection of a patient from the patient list. In some instances, the clinician may need additional information associated with a patient. The additional information may be maintained by clinical applications 260 and/or the EMR 250. By selecting the patient from the patient list, the clinician passes context associated with that patient. In one embodiment, the context includes patient information. In one embodiment, the context includes credentials associated with the clinician. In one embodiment, the context includes the type of data or application requested.

In one embodiment, indication component 236 receives a clinician interaction with the patient list, the interaction associated with an indication of which applications to open. Based on the interaction with the patient in the patient list, the type of data requested is identified. For example, a particular interaction may request data from a single application. A different interaction may request data from multiple applications. Another interaction may request data from all available applications including a video feed application. As can be appreciated the particular interactions and type of data requested may be predefined or configurable by a healthcare facility or the clinician.

Launch component 230 launches more than one application. As described above, the applications that are launched by launch component 230 may be based on context passed from an interaction with the patient list. The context may also include patient information, credentials associated with the clinician, type of data requested, and the like. Launch component 230 passes this context to each application and launches or opens the applications allowing the clinician to efficiently monitor and care for the patient. Rather than launching the full application, launch component 230 may utilize an application programming interface to provide partial functionality or a view of the application.

In one embodiment, hub component 232 centrally manages the patient list and does not require maintaining the patient list within each application. This allows hub component 232 to manage how data is requested and received from each clinical application 260 and the EMR 250 so the proper order and priority can be maintained within the prioritized patient list. Hub component 232, in essence, provides front-end driver functionality for each application communicating with the context engine 220 and enables context engine 220 to open and close each application.

In one embodiment, close component 234 closes each of the applications that have been launched for the patient in the view when a selection of a different patient is received by the patient component. This prevents a clinician from mistakenly opening applications for multiple patients which may result in inaccuracies in monitoring, ordering, diagnosing, prioritizing, or otherwise treating the patients. This can also provide metrics that can be utilized in analytics, such as actual time spent by the clinician for each patient, billing, staffing, and the like.

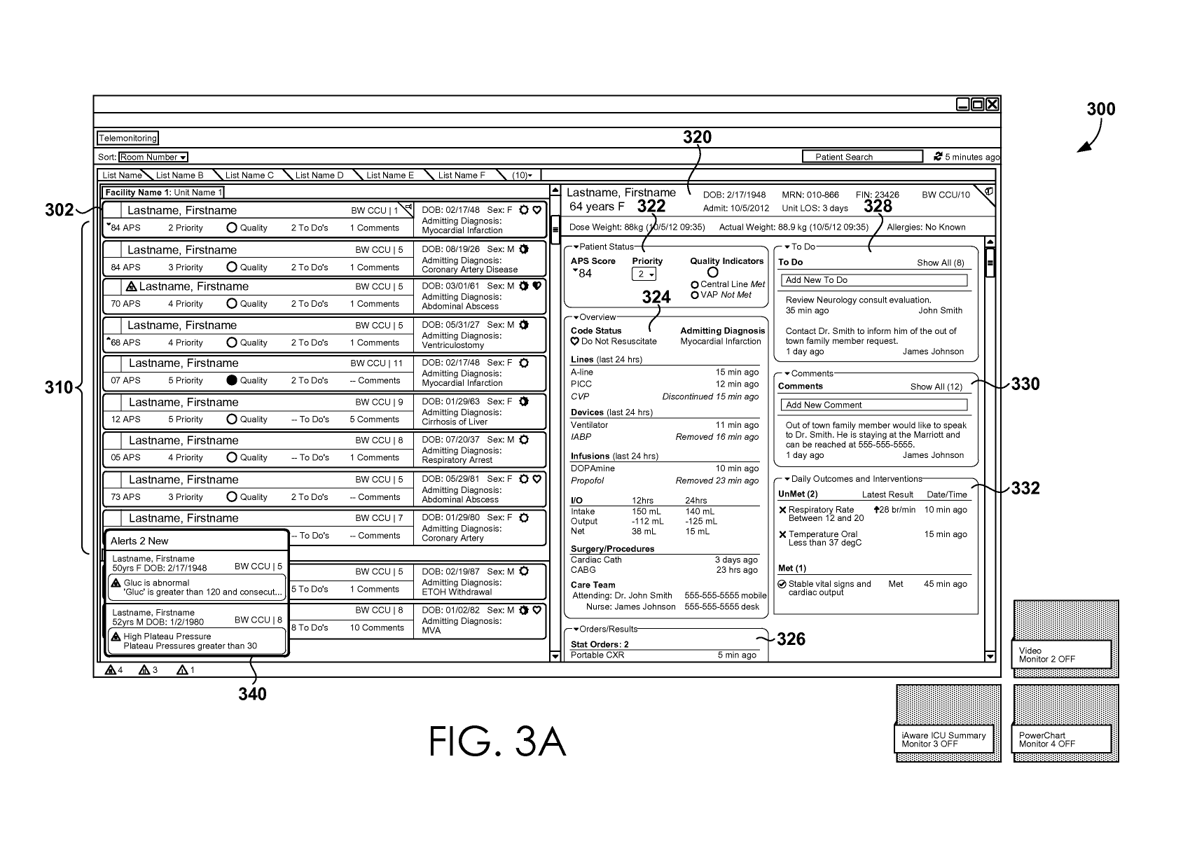

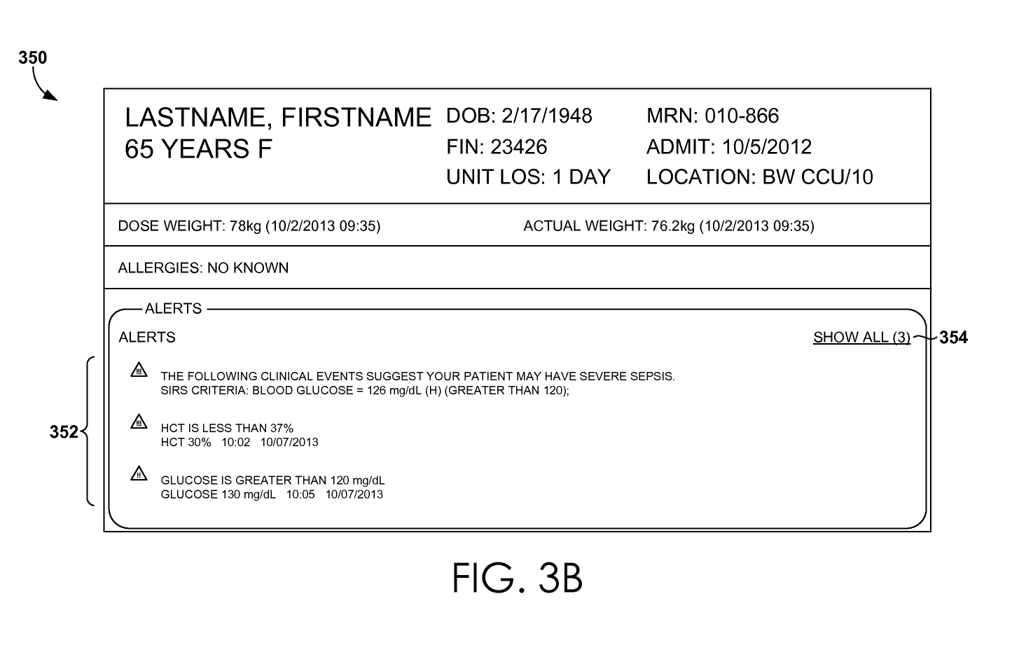

With reference to FIGS. 3-5, illustrative screen displays for maintaining context between applications utilizing prioritized patient lists are provided. It is understood that each of the illustrative screen displays are connected logically, such that they comprise a user interface designed for maintaining context between applications utilizing prioritized patient lists. The screen displays may appear in any order and with any number of screen displays, without regard to whether the screen display is described or depicted herein. The screen displays provide a prioritized patent list and select applications for a telemonitoring scenario. In one embodiment, a portion of screen displays provides a prioritized patient list. In one embodiment, a portion of screen displays provides information for a selected patient. In one embodiment, a portion of screen displays provides a view of more than one clinical application or the EMR associated with a selected patient. In one embodiment, a portion of screen displays provides a view of all available clinical applications, the EMR, and a video feed associated with a selected patient.

Referring now to FIG. 3A, an illustrative screen display 300 of an embodiment of the present invention is shown. A prioritized patient list display area 310 displays a prioritized list comprising a summary of data received from more than one application. The prioritized patient list comprises a selection of patients received from a clinician. As described herein, the patients may be automatically selected based on patient assignments associated with the clinician, a location of the clinician, and/or a role of the clinician. The selection may also be based on information associated with the patients, such as a location of the patient, a diagnosis of the patient, and the like. The selection may also be manually made by the clinician.

The summary of data provided by the prioritized patient list display area 310 may include an Acute Physiology Score (APS). The summary of data may further include a priority that can be generated automatically as described herein or set by the clinician. The summary of data may further include a quality indicator that indicates whether critical care specific measures have been met or not. The summary of data may further include an indicator of how many items are left in a “to do” list for the patient. The summary of data may further include a comments area that allows multiple clinicians associated with the patient to share comments and collaborate without documenting information specifically in the EMR associated with the patient. Other information such as location of the patient, date of birth, gender, status of patient, vitals information, and admitting diagnosis may also be provided in the summary of data.

A patient summary display area 320 displays, after a summary interaction is received for a patient 302, a patient summary for the patient. The patient summary is provided by one of the clinical applications but does not require the application providing the data displayed in the patient summary to be launched locally. In other words, after context is passed based on the interaction to the clinical application, data is provided by the clinical application for display in the patient summary.

The data provided in the patient summary may include a patient status 322. The patient status 322 may include additional information regarding the APS, the priority, and/or the quality indications. The patient status 322 may further allow the clinician to modify the priority and/or the quality indicators.

An overview 324 of the patient may also be provided by the patient summary. The overview may include a code status, an admitting diagnosis, information regarding lines associated with the patient (e.g., current and lines recently discontinued). Device, infusion information, and intake/output information associated with the patient covering a predefined period, such as the previous twenty-four hours, may also be included in the overview. Similarly, information regarding upcoming or recent surgeries or procedures, as well as the care team associated with the patient, may also be included in the overview.

Other items in the patient summary may also include orders and results 326, a detailed “to do” list 328 that may be maintained and updated by more than one clinician, a comments section 330 that allows multiple clinicians to communicate with each other regarding a common patient. The comments section 330 further allows clinicians to provide comments that do not get documented in the EMR associated with the patient. The patient summary may further include daily outcomes and interventions 332 that track both unmet and met outcomes and interventions (e.g., desired respiratory rate, desired oral temperature, stable vital signs, stable cardiac output, and the like). This allows the clinician to quickly determine what the goals are for the patient as well as results associated with the goals (i.e., to identify how close to or far away from the patient is to achieving the goals).

In one embodiment, an alert display area 340 displays, for each patient in the prioritized patient list, a summary of high alerts that have not been acknowledged. The summary of alerts is displayed without launching the application communicating the alerts. In other words, the request for alerts is made in association with the context that is communicated to each application, the EMR, and or the devices. Additional information associated with the alert may be provided by interacting with the summary of alerts (e.g., hovering over or clicking on a particular alert).

Referring now to FIG. 3B, an illustrative screen display 350 of an embodiment of the present invention is shown. The alerts 352 may be grouped by highest priority. For example, high alerts may be followed by medium alerts which may be followed by low/unknown alerts. The most recent alerts of each priority may be displayed first. The alert subject and message for each alert may also be displayed. If more alerts exist than can be displayed in the alerts section, access to view all alerts for a selected patient may be available. A link 354 that allows all alerts to be shown may also be accessible from the alert section 352. If all alerts are already visible, the link may be dithered. Further, the total number of alerts may also be displayed in association with the link 354. If the link is selected, a new link that allows the user to collapse all alerts may be displayed.

The ability to acknowledge an individual alert for a patient may be available within the alert section 352. The acknowledgement, the date/time of the acknowledgement, and the user acknowledging the alert may be maintained and communicated to a log associated with the alerts. Upon acknowledging an alert, the alert may be dithered and remain displayed until a refresh occurs or another patient is selected. The alert icon for the selected patient may be updated accordingly. Similarly, the overall alert count shown for the entire patient list may be updated accordingly.

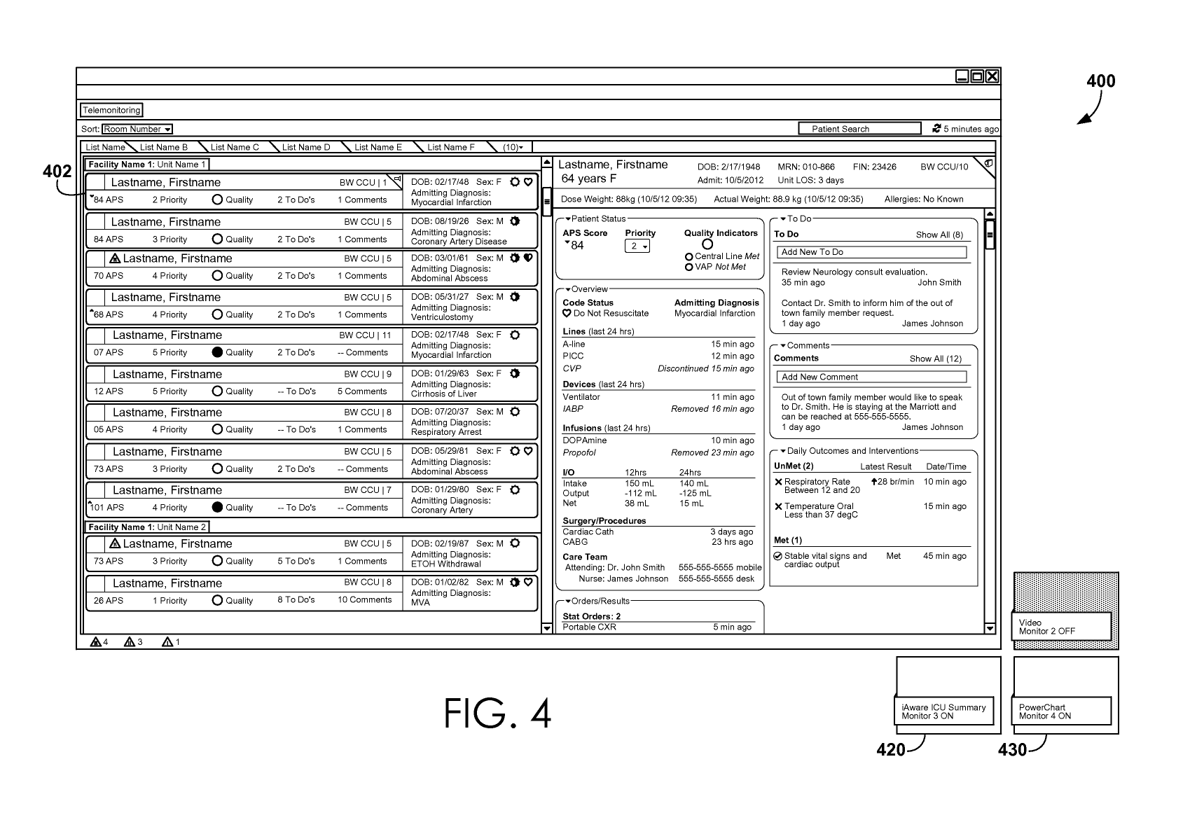

In FIG. 4, an illustrative screen display 400 of an embodiment of the present invention is shown. A patient-specific display area 420, 430 displays, after a patient-specific interaction is received for the selected patient 402, one or more launched applications. The launched applications provide patient-specific information for the patient associated with each launched application. For example, the patient-specific display area 420, 430 may launch a clinical summary application or an EMR application. As can be appreciate, any number of clinical applications can be launched in association with the EMR application for the selected patient 402.

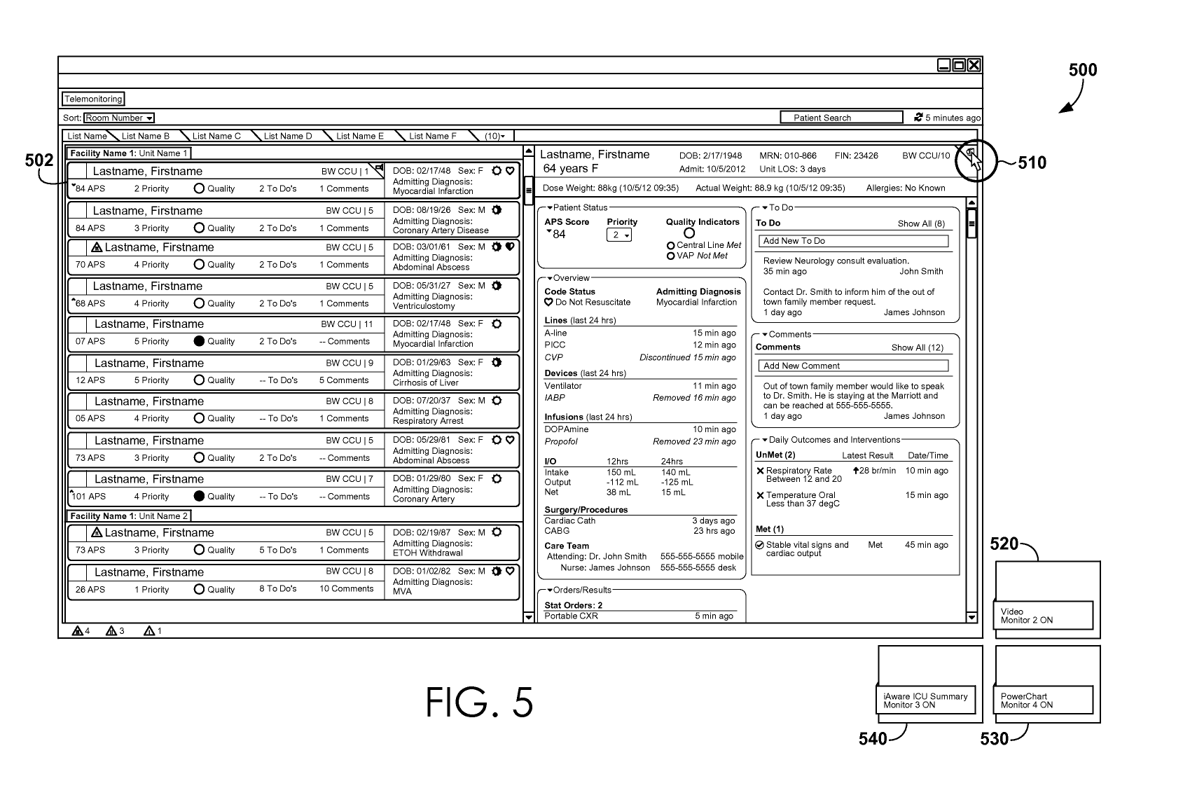

Turning now to FIG. 5, an illustrative screen display 500 of an embodiment of the present invention is shown. A video display area 520, 530, 540 displays, after a video interaction 510 is received for the patient, each of the launched applications for the patient in a view. The view includes a live video feed of the patient. The view may further include a clinical summary application or an EMR application.

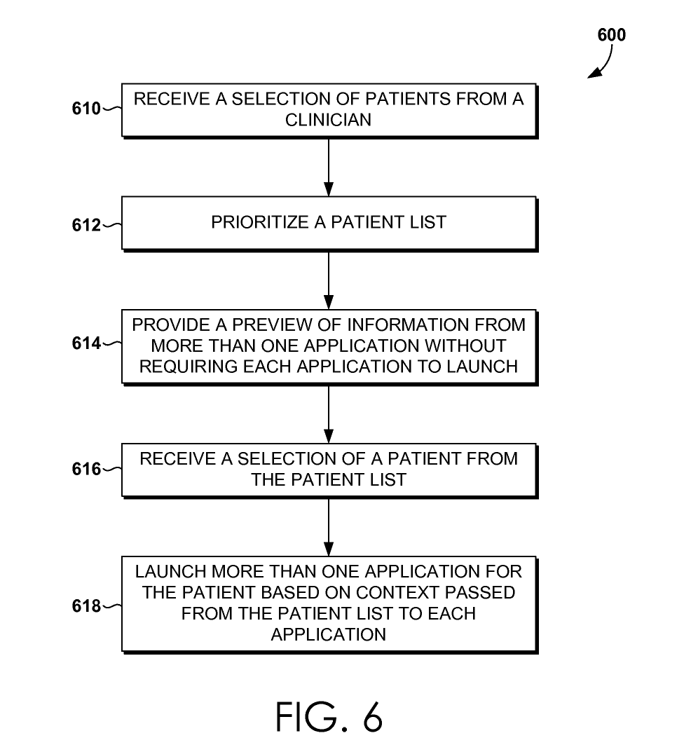

Referring now to FIG. 6, a flow diagram is illustrated showing an exemplary method 600 of maintaining context between applications utilizing prioritized patient lists. As indicated at step 610, a selection of patients is received from a clinician. The selection may be made automatically, such as based on patient assignments associated with the clinician, a location of the clinician, or a role of the clinician. In one embodiment, the selection is based on information associated with the patients, such as location of the patient, a diagnosis of the patient, and the like. In one embodiment, the patients are selected manually by the clinician.

At step 612, a patient list is prioritized. The prioritization may be made automatically based on data received from various medical devices or clinical applications associated with the patients. The prioritization may be based on data received from an EMR associated with each patient. In one embodiment, the prioritization is based on a patient severity of illness score, an APC, or another clinical scoring system. In one embodiment, the prioritization is set or modified manually by the clinician. In one embodiment, the patient list is centrally managed and does not require maintaining a patient list within each application.

A preview of information from more than one application is provided at step 614. The preview is provided without requiring each application to launch. Rather, context associated with each patient in the patient list is provided to each application. Data associated with the patients is received from each application and the context enables the data to be provided for the preview in accordance with the priority of the patient list. For example, the APS associated with each of the patients without opening an APS application for any of the patients. In another example, alerts can be provided for patients in the patient list without opening the underlying application providing the alerts. In one embodiment, an acknowledgement of at least one of the alerts from the patient list is received causing the alerts to be removed from any patient list associated with another clinician that is also responsible for telemonitoring the particular patient for which the alert was acknowledged.

At step 616, a selection of a patient from the patient list is received. The selection may be associated with an indication of which applications to open. The indication may be dependent on a clinical interaction with the patient list. For example, the interaction may be a configurable number of mouse clicks. In another example, the interaction may be a type of gesture. In yet another example, the interaction may be a voice or audible command. In one embodiment, the selection may be made from a video button associated with the patient.

More than one application for the patient is launched, at step 618, based on context passed from the patient list to each application. In one embodiment, selecting the video button described above causes all applications to open for the patient.

In one embodiment, a selection of a different patient form the patient list is received from a clinician. Each of the applications for the patient may be closed prior to providing a summary for the different patient or launching any applications or video feed associated with the different patient. This prevents the clinician from mistakenly monitoring or reviewing information associated with a previously monitored or reviewed patient.

The present invention has been described in relation to particular embodiments, which are intended in all respects to be illustrative rather than restrictive. Further, the present invention is not limited to these embodiments, but variations and modifications may be made without departing from the scope of the present invention.

It will be understood by those of ordinary skill in the art that the order of steps shown in methods 600 of FIG. 6 is not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer hardware storage media storing computer-useable instructions that, when used by one or more computing devices, cause the one or more computing devices to perform a method of maintaining context between applications utilizing prioritized patient lists, the method comprising:
receiving a selection of patients from a clinician;
prioritizing a patient list;
providing a preview of information from more than one application without requiring each application to launch;
receiving a selection of a patient from the patient list; and
launching more than one application for the patient based on context passed from the patient list to each application.

2. The media of claim 1, further comprising providing an Acute Physiology Score (APS) associated with each of the patients in the patient list without opening an APS application for any of the patients.

3. The media of claim 1, wherein the patient list is centrally managed and does not require maintaining a patient list within each application.

4. The media of claim 1, further comprising receiving an acknowledgement of at least one of the alerts from the patient list.

5. The media of claim 1, further comprising receiving, from a clinician, a selection of a different patient from the patient list.

6. The media of claim 5, further comprising closing each of the applications for the patient.

7. The media of claim 6, further comprising launching more than one application for the different patient.

8. The media of claim 1, wherein the selection is associated with an indication of which applications to open.

9. The media of claim 8, wherein the indication is dependent on a clinician interaction with the patient list.

10. The media of claim 9, wherein the interaction is a configurable number of mouse clicks.

11. The media of claim 9, wherein the interaction is a type of gesture.

12. The media of claim 9, wherein the interaction is a voice command.

13. The media of claim 1, wherein the selection is made from a video button associated with the patient causing all applications to open for the patient.

14. A computer system for maintaining context between applications utilizing prioritized patient lists, the computer system comprising one or more processors coupled to a computer storage medium, the computer storage medium having stored thereon a plurality of computer software components executable by the one or more processors, the computer software components comprising:
a selection component that receives a selection of patients from a clinician;
a priority component that prioritizes a patient list;
a preview component that provides a preview of information from more than one application without requiring each application to launch;
a patient component that receives a selection of a patient from the patient list; and
a launch component that launches more than one application based on context passed from the patient list to each application.

15. The computer system of claim 14, further comprising a hub component that centrally manages the patient list and does not require maintaining the patient list within each application.

16. The computer system of claim 14, further comprising a close component that closes each of the applications for the patient when a selection of a different patient is received by the patient component.

17. The computer system of claim 14, further comprising an indication component that receives a clinician interaction with the patient list, the interaction associated with an indication of which applications to open.

18. Computer storage media having computer-executable instructions embodied thereon that, when executed by one or more computing devices, cause the one or more computing devices to produce a graphical user interface (GUI) for maintaining context between applications utilizing prioritized patient lists, the GUI comprising:
a prioritized patient list display area that displays a prioritized patient list comprising a summary of data received from more than one application, the prioritized patient list comprising a selection of patients received from a clinician; and
a patient summary display area that displays, after a summary interaction is received for a patient, a patient summary for the patient provided by one of the applications without launching the application providing data displayed in the patient summary.

19. The media of claim 18, wherein the GUI further comprises:
an alert display area that displays, for each patient in the prioritized patient list, a summary of alerts that have not been acknowledged without launching the application communicating the alerts; and
a patient-specific display area that displays, after a patient-specific interaction is received for the patient, a launched application with patient-specific information for the patient.

20. The GUI of claim 19, further comprising a video display area that displays, after a video interaction is received for the patient, each of the launched applications for the patient in a single application display area that includes a live video feed of the patient.
